(19) United States
(12) Patent Application Publication
(10) Pub. No.: US 2015/0326101 A1
(43) Pub. Date: Nov. 12, 2015

(54) ROTARY ELECTRIC MACHINE

(71) Applicant: KABUSHIKI KAISHA YASKAWA DENKI, Kitakyushu-shi (JP)

(72) Inventors: Toshiyuki ISHIBASHI, Kitakyushu-shi (JP); Takaaki ISHII, Kitakyushu-shi (JP); Atsushi KAWAHARA, Kitakyushu-shi (JP); Sohei OGA, Kitakyushu-shi (JP)

(73) Assignee: KABUSHIKI KAISHA YASKAWA DENKI, Kitakyushu-shi (JP)

(21) Appl. No.: 14/793,687

(22) Filed: Jul. 7, 2015

Related U.S. Application Data
(63) Continuation of application No. PCT/JP2013/084460, filed on Dec. 24, 2013.

(30) Foreign Application Priority Data
Jan. 8, 2013 (JP) PCT/JP2013/050136

(51) Int. Cl. H02K 21/02; H02K 1/27

(52) U.S. Cl. CPC H02K 21/028; H02K 1/2773

(57) ABSTRACT

This disclosure discloses a rotary electric machine including a magnetic body and a rotor core. The magnetic body includes at least a first columnar part, a second columnar part and a third columnar part. The rotor core includes an outer peripheral part, a first inner peripheral part, a second inner peripheral part, a first connecting part and a second connecting part. The first inner peripheral part is capable of facing a radial outer side of the first columnar part. The second inner peripheral part is capable of facing a radial outer side of the second columnar part.

### CROSS-REFERENCE TO RELATED APPLICATION

This is a continuation application PCT/JP2013/084460, filed Dec. 24, 2013, which was published under PCT article 21(2) in English.

### TECHNICAL FIELD

Embodiments disclosed herein relate to rotary electric machines.

### BACKGROUND

A rotary electric machine capable of adjusting its characteristics by a stator that axially moves to change an area where the stator faces a rotor is known.

### SUMMARY

According to one aspect of the disclosure, there is provided a rotary electric machine including a magnetic body, a rotatable shaft body, a rotor core, a stator core and first windings. The magnetic body includes at least a first columnar part located on an axial one side, a second columnar part located on an axial other side, a third columnar part located at an axial intermediate part between the first columnar part and the second columnar part. The shaft body includes a space capable of housing the magnetic body. The rotor core includes an outer peripheral part, a first inner peripheral part, a second inner peripheral part, a first connecting part and a second connecting part. The outer peripheral part is fixed to the shaft body, and the outer peripheral part includes a first magnet pole part and a second magnet pole part alternately arranged extending along a circumferential direction, the first magnet pole part and second magnet pole part each have a different magnet pole direction with respect to a radial direction. The first inner peripheral part is disposed on the axial one side on a radial inner side of the outer peripheral part, and the first inner peripheral part is capable of facing a radial outer side of the first columnar part. The second inner peripheral part is disposed on the axial other side on the radial inner side of the outer peripheral part, and the second inner peripheral part is capable of facing a radial outer side of the second columnar part. The first connecting part radially connects the first inner peripheral part and an arrangement part of the first magnetic pole part of the outer peripheral part. The second connecting part radially connects the second inner peripheral part and an arrangement part of the second magnetic pole part of the outer peripheral part. The stator core is disposed on a radial outer side of the rotor core. The first windings are disposed on the stator core.

### BRIEF DESCRIPTION OF THE DRAWING

FIG. 1 is an axial cross-sectional view representing a whole configuration of a rotary electric machine of a first embodiment.

FIG. 2 is an external view of a shaft body in the rotary electric machine.

FIG. 3A is a transverse cross-sectional view along an A-A′ line in FIG. 1.

FIG. 3B is a transverse cross-sectional view along a B-B′ line in FIG. 1.

FIG. 3C is a transverse cross-sectional view along a C-C′ line in FIG. 1.

FIG. 4 is a perspective view illustrating a half body obtained by cutting a rotor core and the inside thereof of the rotary electric machine in an axial direction.

FIG. 5A is a conceptional axial cross-sectional view illustrating a magnetic body and rotor core in a first state.

FIG. 5B is a conceptional axial cross-sectional view illustrating the magnetic body and rotor core in a second state.

FIG. 6 is an axial cross-sectional view representing the rotary electric machine whose magnetic body and rotor core are in the second state.

FIG. 7 is a conceptional axial cross-sectional view illustrating a magnetic body and rotor core in a variation, in which the magnetic body is configured in a multi stage.

FIG. 8 is a conceptional axial cross-sectional view illustrating a magnetic body and rotor core in a variation, in which a permanent magnet is disposed on a first larger diameter part and a second larger diameter part of the magnetic body.

FIG. 9 is a conceptional axial cross-sectional view illustrating a magnetic body and rotor core in a variation, in which a permanent magnet is disposed on a first smaller diameter part of the magnetic body.

FIG. 10A is an axial cross-sectional view in a first state of a magnetic body and rotor core of a rotary electric machine in a variation, in which the magnetic body is divided into two pieces that can be axially driven toward opposite sides, respectively.

FIG. 10B is an axial cross-sectional view in a second state of the magnetic body and rotor core of the rotary electric machine in the variation, in which the magnetic body is divided into two pieces that can be axially driven toward opposite sides, respectively.

FIG. 11A is a conceptional axial cross-sectional view illustrating a magnetic body and rotor core in a second embodiment,

FIG. 11B is a transverse cross-sectional view along an F-F′ line in FIG. 11A.

FIG. 11C is a conceptional axial cross-sectional view illustrating the magnetic body and rotor core in a state after rotation,

FIG. 11D is a transverse cross-sectional view along a G-G′ line in FIG. 11C.

FIG. 12 is an axial cross-sectional view representing a whole configuration of a rotary electric machine of a third embodiment.

FIG. 13 is an external view of a shaft body in the rotary electric machine.

FIG. 14A is a transverse cross-sectional view along an H-H′ line in FIG. 12.

FIG. 14B is a transverse cross-sectional view along an I-I′ line in FIG. 12.

FIG. 14C is a transverse cross-sectional view along a J-J′ line in FIG. 12.

FIG. 15 is a perspective view of a half body obtained by cutting a rotor core and the inside thereof of a rotary electric machine of the fourth embodiment into a sector form with an inner periphery angle of 135° when seen from an axial transverse cross-section.

FIG. 16A is a transverse cross-sectional view corresponding to FIG. 3A, in the rotary electric machine of the fourth embodiment.

FIG. 16B is a transverse cross-sectional view corresponding to FIG. 3B, in the rotary electric machine of the fourth embodiment.

FIG. 16C is a transverse cross-sectional view corresponding to FIG. 3C, in the rotary electric machine of the fourth embodiment.

FIG. 17A is a transverse cross-sectional view corresponding to FIG. 14A and FIG. 16A, in a rotary electric machine obtained by combining the third embodiment and the fourth embodiment.

FIG. 17B is a transverse cross-sectional view corresponding to FIG. 14B and FIG. 16B, in the rotary electric machine obtained by combining the third embodiment and the fourth embodiment.

FIG. 17C is a transverse cross-sectional view corresponding to FIG. 14C and FIG. 16C, in the rotary electric machine obtained by combining the third embodiment and the fourth embodiment.

### DESCRIPTION OF THE EMBODIMENTS

Hereinafter, embodiments will be described with reference to the accompanying drawings.

<Whole Configuration of Rotary Electric Machine>

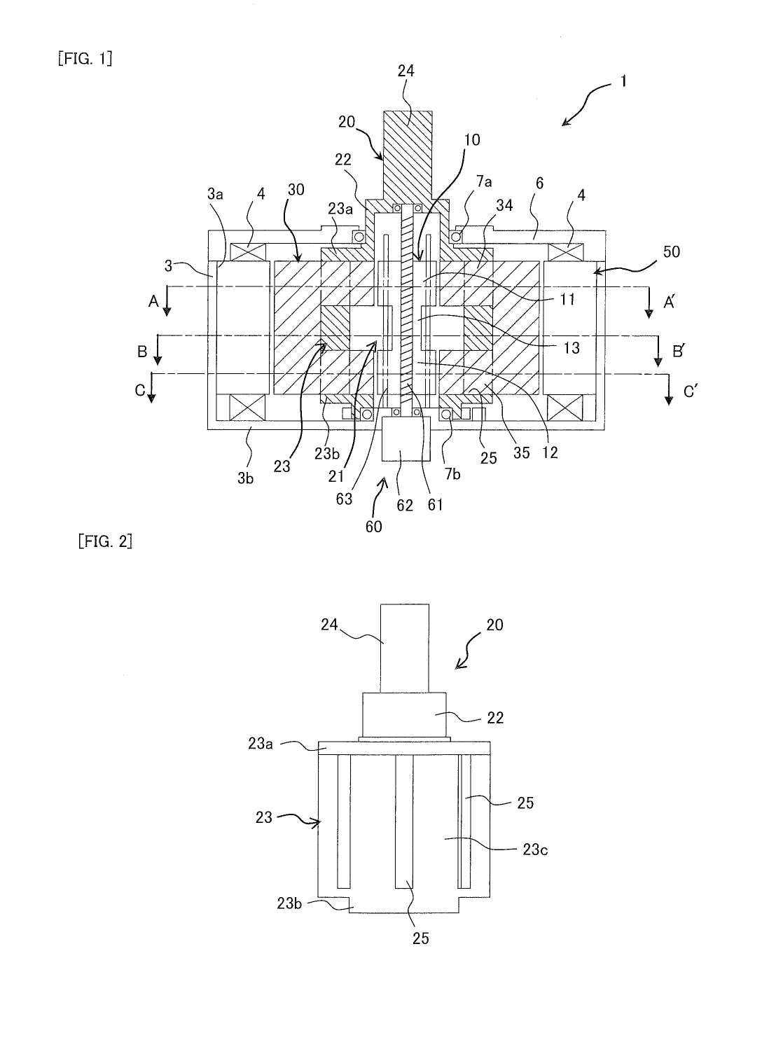

First, the whole configuration of a rotary electric machine of a first embodiment is described using FIG. 1 and FIG. 2. FIG. 1 is an axial cross-sectional view of the rotary electric machine, and FIG. 2 is an external view of a shaft body in the rotary electric machine.

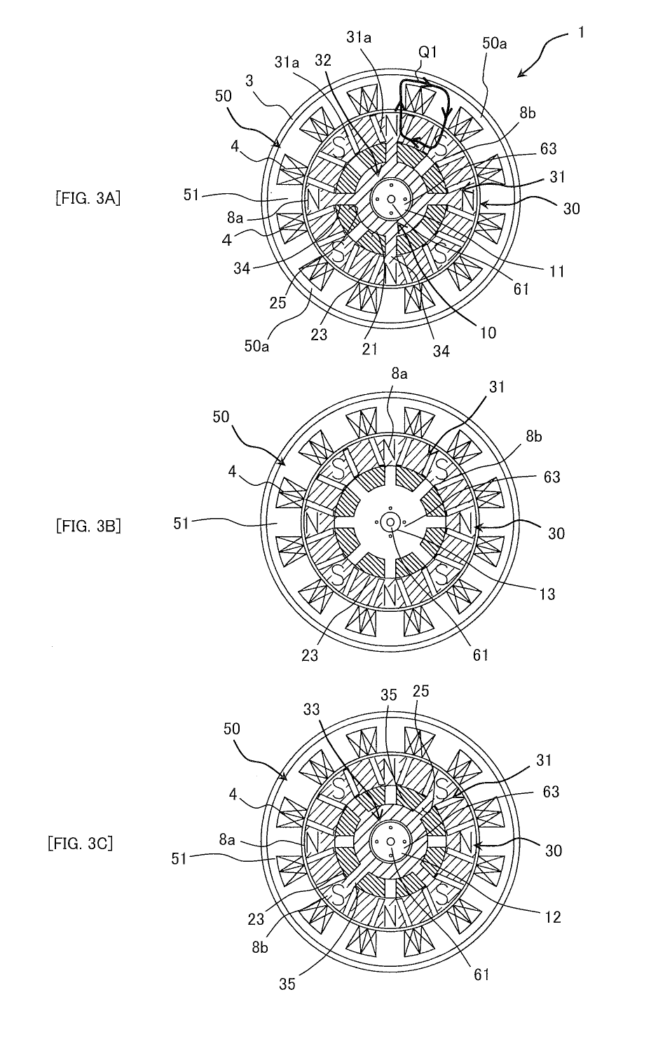

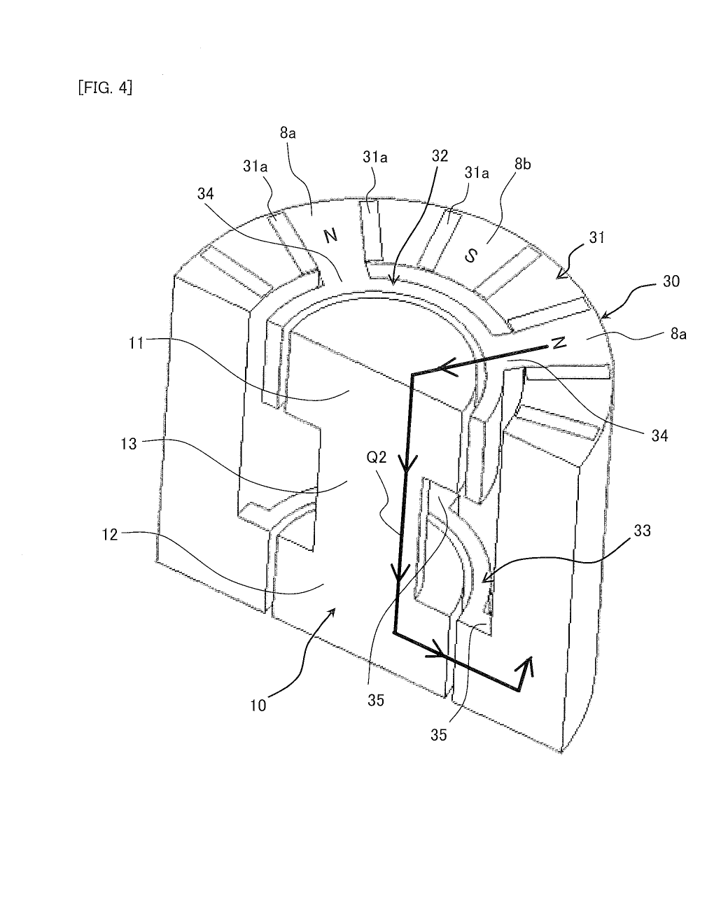

As illustrated in FIG. 1, the rotary electric machine 1 includes: a magnetic body 10; a shaft body 20 having, in a center part in a radial direction, a space 21 capable of housing the magnetic body 10; a rotor core 30 fixed to the shaft body 20; a stator core 50 disposed on a radial outer side of the rotor core 30; a field yoke 50a (see FIG. 3 described later) disposed on a radial outer part of the stator core 50; windings 4 (corresponding to an example of first windings) disposed on the stator core 50; and an axial driving mechanism 60 capable of axially displacing the magnetic body 10 in the space 21 of the shaft body 20.

A case 3 is formed in a cylindrical shape whose axial one side (upper side in FIG. 1) is opened and whose axial other side (lower side in FIG. 1) is closed. An opening part 3a on the axial one side of the case 3 is closed by a lid body 6 which the shaft body 20 extends through.

An axial one side part of the shaft body 20 is rotatably supported on the lid body 6 by a shaft bearing 7a. An axial other side part of the shaft body 20 is rotatably supported on a bottom wall part 3b of the case 3 by a shaft bearing 7b. Moreover, the shaft body 20 includes, as illustrated in FIG. 2 and FIG. 1, a bottomed cylindrical body part 23, a small cylindrical hollow flange part 22 disposed on the axial one side of the cylindrical body part 23, and a shaft part 24 disposed on the axial one side of the flange part 22. An inner hollow part of the flange part 22 and an inner hollow part of the cylindrical body part 23 communicate with each other to form the space 21. In the cylindrical body part 23, as illustrated in FIG. 2 a plurality of (eight in this example) slits 25 are circumferentially disposed on a predetermined interval on a peripheral wall part 23c.

The slit 25 has a rectangular shape that extends from directly under a top plate part 23a on the axial one side (upper side in FIG. 2) of the cylindrical body part 23 to a vicinity of a bottom part 23b on the axial other side (lower side in FIG. 2). Moreover, the slit 25 radially extends through and communicates with the space 21.

<Cross-Sectional Structure of Magnetic Body and Peripheral Thereof>

FIG. 3A is a transverse cross-sectional view along an A-A′ line in FIG. 1. FIG. 3B is a transverse cross-sectional view along a B-B′ line in FIG. 1. FIG. 3C is a transverse cross-sectional view along a C-C′ line in FIG. 1. FIG. 4 is a perspective view illustrating a half body obtained by axially cutting a rotor core of the rotary electric machine and the inside thereof.

The magnetic body 10 includes, as illustrated in FIG. 3A to FIG. 3C, FIG. 4, and FIG. 1, a first larger diameter part 11 (corresponding to an example of a first columnar part) located on the axial one side (upper side in FIG. 4), a second larger diameter part 12 (corresponding to an example of a second columnar part) located on the axial other side (lower side in FIG. 4), and a first smaller diameter part 13 (corresponding to an example of a third columnar part) located at an axial intermediate part between these first larger diameter part 11 and second larger diameter part 12.

The rotor core 30 includes an annular outer peripheral part 31, a first annular inner peripheral part 32 disposed on the axial one side on the radial inner side of the outer peripheral part 31, a second annular inner peripheral part 33 disposed on the axial other side on the radial inner side of the outer peripheral part 31, a first connecting part 34 that radially connects the first inner peripheral part 32 and the outer peripheral part 31, and a second connecting part 35 that radially connects the second inner peripheral part 33 and the outer peripheral part 31. Here, the outer peripheral part 31 is mated into an outer peripheral surface of the cylindrical body part 23 of the shaft body 20. The first inner peripheral part 32 and the second inner peripheral part 33 are mated into an inner peripheral surface of the cylindrical body part 23. The first connecting part 34 and the second connecting part 35 are mated into the slit 25 of the peripheral wall part 23c of the cylindrical body part 23. The rotor core 30 is fixed to the top plate part 23a and bottom wall part 23b of the shaft body 20, with the outer peripheral part 31, first inner peripheral part 32, second inner peripheral part 33, first connecting part 34, and second connecting part 35 being mated as described above.

The first inner peripheral part 32 faces the radial outer side of the first larger diameter part 11 when the magnetic body 10 is at the position illustrated in FIG. 1 and FIG. 4. Similarly, the second inner peripheral part 33 faces the radial outer side of the second larger diameter part 12 when the magnetic body 10 is at the position illustrated in FIG. 1 and FIG. 4.

In this example, the outer peripheral part 31 is circumferentially partitioned by a tabular permanent magnet 31a so that an area whose cross section is truncated cone-shaped and an area whose cross section is rectangular are alternately formed. The axial length of the tabular permanent magnet 31a is set to be the same as the rotor core 30. The tabular permanent magnet 31a extends through the outer peripheral part 31 in parallel to the central axial direction of the rotor core 30. The permanent magnet 31a is magnetized in the thickness direction of each tabular shape (in the substantially circumferential direction of the rotor core 30). The magnetization direction of each permanent magnet 31a is substantially opposite to each other in the circumferential direction between two permanent magnets 31a that sandwich each area whose cross section is truncated cone-shaped, and faces in substantially the same direction in the circumferential direction between two permanent magnets 31a that sandwich each area whose cross section is rectangular. The area, whose cross section is truncated cone-shaped, sandwiched by two permanent magnets 31a having N-polarity and facing each other serves as an N-magnetic pole (corresponding to an example of a first pole) part 8a that radiates an N-magnetic pole flux to each of the radially outward and the radially inward. The area, whose cross section is truncated cone-shaped, sandwiched by two permanent magnets 31a having S-polarity and facing each other serves as an S-magnetic pole (corresponding to an example of a second pole) part 8b that radiates an S-magnetic pole flux to each of the radially outward and the radially inward. As a result, focusing on the area whose cross section is truncated cone-shaped, a plurality of N-magnetic pole parts 8a and S-magnetic pole parts 8b (in this example, four N-magnetic pole parts 8a and four S-magnetic pole parts 8b) whose polarity direction with respect to the radial direction differs from each other are alternately arranged extending along the circumferential direction.

The first connecting part 34 radially connects the first inner peripheral part 32 and the outer peripheral part 31 at an arrangement part of the N-magnetic pole part 8a. The second connecting part 35 radially connects the second inner peripheral part 33 and the outer peripheral part 31 at an arrangement part of the S-magnetic pole part 8b.

The stator core 50 is spaced apart by a magnetic gap from the outer peripheral surface of the rotor core 30. On the inner peripheral side of the stator core 50, a plurality of teeth 51 each radially projecting inward is arranged extending along the circumferential direction. The windings 4 are wound around the teeth 51 of the stator core 50, and are disposed on the stator core 50 so as to from a magnetic circuit between the field yoke 50a and the rotor core 30.

<Axial Driving Mechanism>

The axial driving mechanism 60 includes, as illustrated in FIG. 1 and FIG. 3, a motor 62, a ball screw 61 that is fixed to the axial one side of the motor shaft of the motor 62 and screwed into an axis part of the magnetic body 10, and a plurality of guide rods 63 axially disposed around the ball screw 61.

The axial one side and axial other side projecting from the magnetic body 10 of the ball screw 61 are rotatably supported on the flange part 22 of the shaft body 20 and on the bottom wall part 3c of the case 3, respectively. The ball screw 61 is clockwise threaded, for example. On the other hand, the guide rod 63 engages with the first larger diameter part 11 and second larger diameter part 12 of the magnetic body 10. The magnetic body 10 is allowed to axially move but prevented from rotating around the shaft by the guide rod 63.

<Axial Movement of Magnetic Body>

Thanks to the configuration of the axial driving mechanism 60 as described above, if the ball screw 61 rotates clockwise by rotational drive of the motor 62, then in the space 21 of the shaft body 20, the magnetic body 10 moves to the axial one side while being guided by the guide rod 63. On the contrary, if the ball screw 61 rotates counterclockwise by rotational drive of the motor 62, then in the space 21 of the shaft body 20, the magnetic body 10 moves to the axial other side while being guided by the guide rod 63. As described above, the magnetic body 10 is capable of displacing its axial position in the space 21 of the shaft body 20 thanks to the axial driving mechanism 60.

<Operation and Operational Effect>

Next, the operation of the rotary electric machine having the configuration of the embodiment is described.

<In a State where Two Magnetic Circuits are Formed>

In the state (hereinafter, referred to as a first state as needed) illustrated in FIG. 1 and FIG. 4, as described above, the first larger diameter part 11 and second larger diameter part 12 of the magnetic body 10 face the first inner peripheral part 32 and second inner peripheral part 33 of the rotor core 30, respectively. In this state, as illustrated in FIG. 3, the lines of magnetic force emanating from the N-magnetic pole part 8a of the rotor core 30 radially crosses the stator core 50 and extend to the field yoke 50a, and go around the field yoke 50a on both sides (in FIG. 3, only the right side is illustrated) in the circumferential direction of the field yoke 50a, and subsequently radially cross the stator core 50 and returns to two adjacent S-magnetic pole parts 8b that sandwich the N-pole of the rotor core 30. As a result, a magnetic circuit (hereinafter, referred to as a “first magnetic circuit” as needed) Q1 is radially formed between the field yoke 50a and the rotor core 30. When in this state an electric current is fed to the windings 4 disposed on the stator core 50, a rotational force is generated in the rotor core 30, which is fixed to the shaft body 20, by an interaction between the lines of magnetic force generated in the coil of the windings 4 and the first magnetic circuit Q1, so that the rotor including the rotor core 30 is rotationally driven in the rotary electric machine 1.

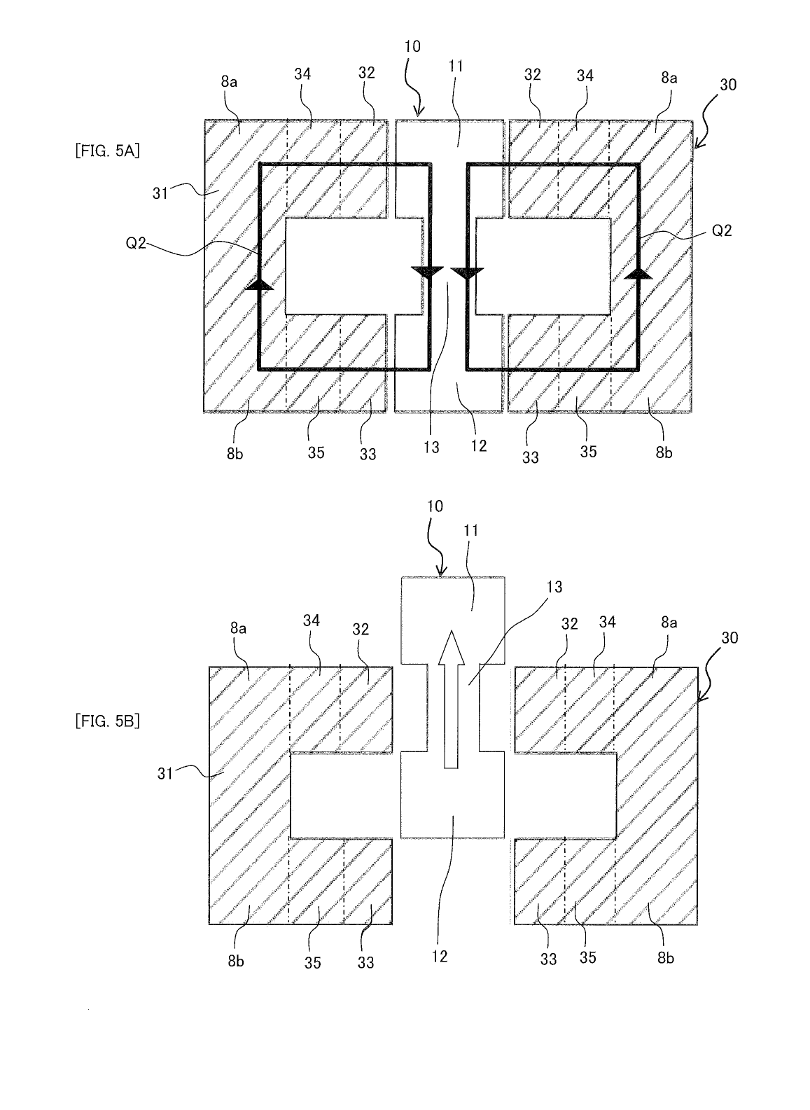

On the other hand, at this time, as described above, the first larger diameter part 11 and the second larger diameter part 12 face the first inner peripheral part 32 and the second inner peripheral part 33, respectively. As a result, as illustrated in FIG. 5A and FIG. 4, a magnetic circuit (hereinafter, referred to as a “second magnetic circuit” as needed) Q2 different from the first magnetic circuit Q1 that generates the rotational drive force is formed, the second magnetic circuit Q2 having the following paths: the N-magnetic pole part 8a of the outer peripheral part 31 of the rotor core 30→the first connecting part 34→the first inner peripheral part 32→the first larger diameter part 11 of the magnetic body 10 in the radial direction, and furthermore the first larger diameter part 11 of the magnetic body 10→the first smaller diameter part 13→the second larger diameter part 12 in the radial direction and furthermore the second larger diameter part 12→the second inner peripheral part 33 of the rotor core 30→the second connecting part 35→the S-magnetic pole part 8b of the outer peripheral part 31. Note that, in FIG. 5A, the first connecting part 34 and the second connecting part 35 are illustrated on the same plane for convenience of description, but actually they are circumferentially shifted from each other and are not on the same plane (this is true of FIG. 5B described later).

<In a State where One Magnetic Circuit is Formed>

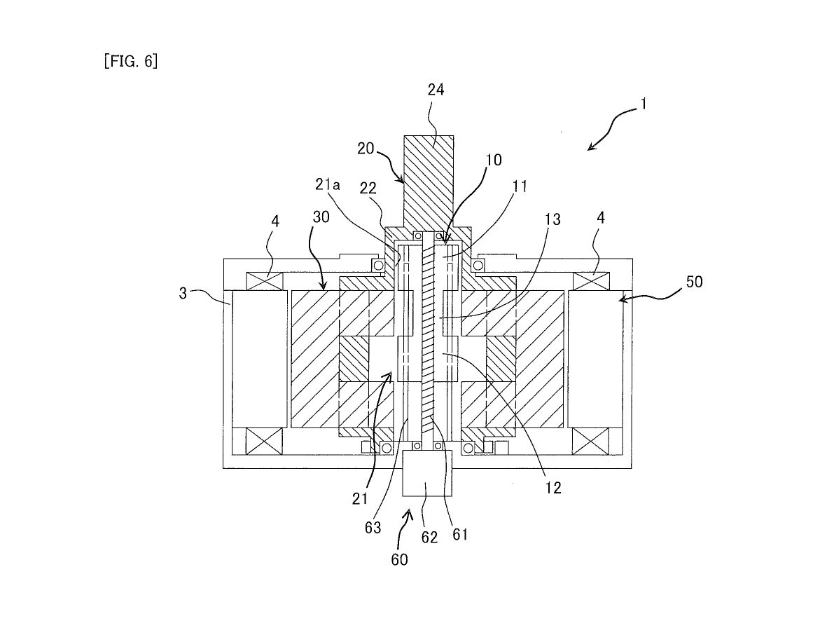

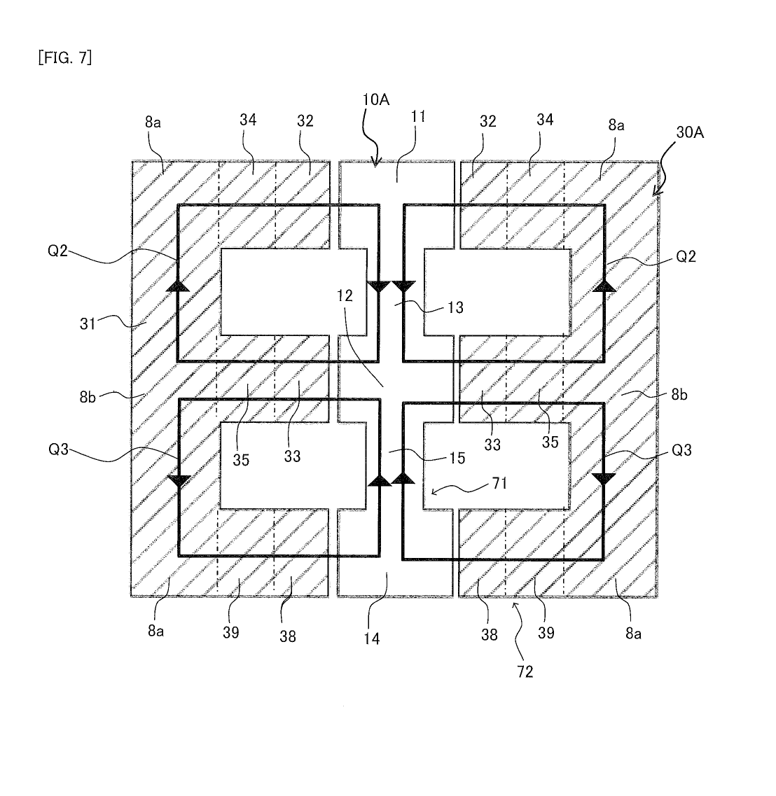

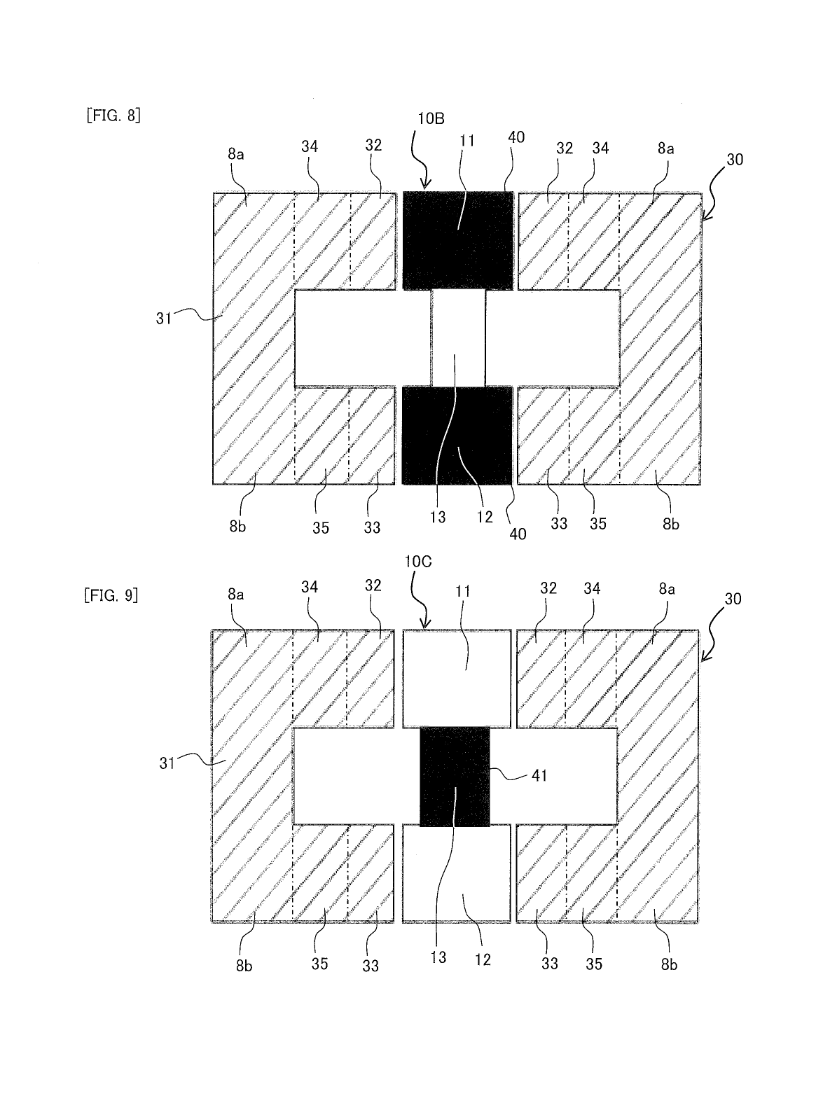

For example, if the magnetic body 10 is displaced from the state illustrated in FIG. 1 and FIG. 4 to the axial one side (upper side in FIG. 6) in the space 21 of the shaft body 20 by the axial driving mechanism 60, then as illustrated in FIG. 6, the first larger diameter part 11 is located in a space 21a inside the flange part 22 of the space 21 of the shaft body 20. In this state (hereinafter, referred to as a “second state” as needed), the first larger diameter part 11 and second larger diameter part 12 of the magnetic body 10 are at positions where they do not face the first inner peripheral part 32 and second inner peripheral part 33 of the rotor core 30, respectively, anymore. In this state, as illustrated in FIG. 5B, because the first larger diameter part 11 and second larger diameter part 12 do not face the first inner peripheral part 32 and second inner peripheral part 33, respectively, the second magnetic circuit Q2 disappears. Note that, the first magnetic circuit Q1 does not disappear but is formed even in the second state, and an electric current is fed to the windings 4 as described above to generate a rotational force in the rotor core 30.

<Operational Effect of the Embodiment>

As described above, in this embodiment, by the axial driving mechanism 60 that axially displaces the magnetic body 10 as needed, the first state, in which the first larger diameter part 11 and second larger diameter part 12 of the magnetic body 10 are caused to face the first inner peripheral part 32 and second inner peripheral part 33 of the rotor core 30, respectively, to form the second magnetic circuit Q2, and the second state, in which the first larger diameter part 11 and second larger diameter part 12 do not face the first inner peripheral part 32 and second inner peripheral part 33, respectively, and the second magnetic circuit Q2 disappears, can be switched.

As a result, for example, the density of magnetic flux of the first magnetic circuit Q1 can be increased by reducing the density of magnetic flux of the second magnetic circuit Q2, or the density of magnetic flux of the first magnetic circuit Q1 can be reduced by increasing the density of magnetic flux of the second magnetic circuit Q2. Moreover, a state intermediate between the first state and the second state can be also realized by appropriately adjusting the amount of displacement. As a result, a high-torque characteristic and/or a high-speed characteristic can be flexibly realized by appropriately adjusting the density of magnetic flux of the first magnetic circuit Q1. At this time, as described above, because the density of magnetic flux itself contributing to the rotational drive of the rotor can be increased/decreased and adjusted, a loss due to a leakage of the magnetic flux can be prevented to improve the efficiency unlike the technique for increasing/decreasing a leakage of the magnetic flux from the magnetic circuit contributing to the rotational drive of the rotor.

The structure that axially displaces the magnetic body 10 corresponds to an example of means for adjusting a balance of a magnetic flux density of a first magnetic circuit and a magnetic flux density of a second magnetic circuit described in claims.

Note that, the first embodiment is not limited to the above-described contents, but various variations are possible. Hereinafter, such variations are described one by one. The same reference numeral is given to the part equivalent to the first embodiment to omit or simplify the description thereof as needed.

(1) When a magnetic body is formed in a multi stage.

In this variation, as illustrated in FIG. 7, a magnetic body 10A includes, as with the magnetic body 10, the first larger diameter part 11 on the axial one side (upper side in FIG. 7), the second larger diameter part 12 on the axial other side (lower side in FIG. 7), and the first smaller diameter part 13 located at an axial intermediate part, and additionally includes a third larger diameter part 14 (corresponding to an example of a fifth columnar part) located on further the axial other side of the second larger diameter part 12 (in other words, on further the axial other side of a second smaller diameter part 15 described later), and the second smaller diameter part 15 (corresponding to an example of a fourth columnar part) located at an axial intermediate part between the second larger diameter part 12 and the third larger diameter part 14. Note that the second smaller diameter part 15 and third larger diameter part 14 constitute a first extension part 71.

Moreover, a rotor core 30A is disposed on further the axial other side of the second inner peripheral part 33 on the radial inner side of the outer peripheral part 31, and includes a third inner peripheral part 38 capable of facing the radial outer side of the third larger diameter part 14 and a third connecting part 39 that radially connects the third inner peripheral part 38 and the arrangement part of the N-magnetic pole part 8a of the outer peripheral part 31. Note that the third inner peripheral part 38 and third connecting part 39 constitute a second extension part 72. Moreover, radial driving of the magnetic body 10A, though the description thereof is omitted here, is performed by a configuration similar to the axial driving mechanism 60 of the first embodiment.

As a result, in the state illustrated in FIG. 7 corresponding to an example of the first state, in addition to the second magnetic circuit Q2 as described above, the second magnetic circuit Q2 having the following path: the N-magnetic pole part 8a of the outer peripheral part 31 of the rotor core 30A the first connecting part 34→the first inner peripheral part 32→the first larger diameter part 11 of the magnetic body 10A→the first smaller diameter part 13→the second larger diameter part 12→the second inner peripheral part 33 of the rotor core 30A→the second connecting part 35 the S-magnetic pole part 8b of the outer peripheral part 31, a magnetic circuit (hereinafter, referred to as a “third magnetic circuit” as needed) Q3 different from the second magnetic circuit Q2 is formed, the third magnetic circuit having the following paths: the N-magnetic pole part 8a of the outer peripheral part 31 of the rotor core 30A→the third connecting part 39→the third inner peripheral part 38→the third larger diameter part 14 of the magnetic body 10A in the radial direction, and furthermore the third larger diameter part 14→the second smaller diameter part 15→the second larger diameter part 12 in the axial direction and furthermore the second larger diameter part 12→the second inner peripheral part 33 of the rotor core 30A→the second connecting part 35→the S-magnetic pole part 8b of the outer peripheral part 31. That is, two magnetic circuits (the second magnetic circuit Q2 and the magnetic circuit Q3 having a function equivalent to the function of the second magnetic circuit Q2) each constituting a path different from the first magnetic circuit Q1 as described above will be formed.

Thanks to the above-described configuration, in this variation even when the rotary electric machine 1 has a relatively long structure in the axial direction, a density of magnetic flux similar to the above-described density of magnetic flux can be reliably achieved. Moreover, even when the structure of the rotary electric machine 1 is not long in the axial direction, two magnetic circuits, i.e., the second magnetic circuit Q2 and the magnetic circuit Q3 having a function equivalent to the function of the second magnetic circuit Q2, are formed. Therefore, when the magnetic body is axially displaced as described above to adjust the characteristics of the rotary electric machine, the amount of displacement (stroke) can be reduced.

Note that, in the above-described example, a case below has been described as an example.

Here, one first extension part 71 described above including the second smaller diameter part 15 and the third larger diameter part 14 is added to the magnetic body 10, in the first embodiment, including

the first larger diameter part 11 on the axial one side, the second larger diameter part 12 on the axial other side, and the first smaller diameter part 13 in the axial intermediate part,

and furthermore one second extension part 72 described above which is the same number as the number of the first extension parts 71 including the third inner peripheral part 38 and the third connecting part 39 is added to the rotor core 30, including

the first inner peripheral part 32 on the axial one side, the second inner peripheral part 33 on the axial other side, the first connecting part 34 that connects the first inner peripheral part 32 and the outer peripheral part 31, and the second connecting part 35 that connects the second inner peripheral part 33 and the outer peripheral part 31. However, the present disclosure is not limited to this case. That is, a plurality of stages of the first extension part 71 and second extension part 72 may be disposed on the axial other side of the magnetic body 10 and rotor core 30 of the first embodiment. As the number of stages is increased further, a stroke reducing effect can be further increased.

(2) When a permanent magnet is disposed on the larger diameter part.

In this variation, as illustrated in FIG. 8, a ring-shaped permanent magnet 40 is disposed on the outer peripheral part of the first larger diameter part 11 and second larger diameter part 12 of a magnetic body 10B, respectively. Note that the ring-shaped permanent magnet 40 may be disposed only on either one of the first larger diameter part 11 and the second larger diameter part 12. The configuration other than the above is the same as that of the first embodiment.

In this variation, thanks to the above-described configuration, the amount of change of the magnetic flux when the magnetic body 10B is axially displaced can be increased.

Note that, when the first larger diameter part 11, the second larger diameter part 12, and the third larger diameter part 14 are disposed on the magnetic body 10B as with the variation (1), the ring-shaped permanent magnets 40 can be disposed on either one or two or all of them. In this case, as with this variation, the amount of change of the magnetic flux when the magnetic body is axially displaced can be increased.

(3) When a permanent magnet is disposed on the smaller diameter part.

In this variation, as illustrated in FIG. 9, a ring-shaped permanent magnet 41 is disposed on the outer peripheral part of the smaller diameter part 13 of a magnetic body 10C. The configuration other than the above is the same as that of the first embodiment.

In this variation, thanks to the above-described configuration, as with the variation (2), the amount of change of the magnetic flux when the magnetic body 10C is axially displaced can be increased.

Note that, in a case where the first smaller diameter part 13 and second smaller diameter part 15 are disposed on the magnetic body 10C as with the variation (1), a tabular permanent magnet 41 can be disposed on either one or both of them, and also in this case, the same effect as this variation can be obtained.

(4) When a magnetic body has a divided structure.

That is, as illustrated in FIG. 10A, in a rotary electric machine 1D of this variation, a magnetic body 10D is divided into a first piece 10a including the first larger diameter part 11 on an axial one side (upper side in FIG. 10A) and a second piece 10b including the second larger diameter part 12 on an axial other side (lower side in FIG. 10A) (hereinafter, these first and second pieces 10a and 10b are collectively and simply referred to as the “magnetic body 10D” as needed). A first smaller diameter part 13a corresponding to the first smaller diameter part 13 of the first embodiment is disposed on an axial other side of the first larger diameter part 11 of the first piece 10a, while a first smaller diameter part 13b corresponding to the first smaller diameter part 13 of the first embodiment is disposed on an axial one side of the second larger diameter part 12 of the second piece 10b.

An axial driving mechanism 60D includes a ball screw 64 that is screwed into the axis part of the first piece 10a and second piece 10b while extending therethrough. For example, a thread part 64a extending through the first piece 10a on an axial one side of the ball screw 64 is clockwise threaded, while a thread part 64b extending through the second piece 10b on an axial other side of the ball screw 64 is counterclockwise threaded. The guide rod 63 engages with the first larger diameter part 11 and second larger diameter part 12 of the magnetic body 10D including the first piece 10a and second piece 10b. The magnetic body 10D is allowed to axially move but prevented from rotating around the shaft by the guide rod 63.

Thanks to the configuration of the axial driving mechanisms 60D as described above, for example if the ball screw 64 rotates clockwise by rotational drive of the motor 62, then in the space 21 of the shaft body 20, as illustrated in FIG. 10B, the first piece 10a moves to an axial one side (upper side in FIG. 10B) and the second piece 10b moves to an axial other side (lower side in FIG. 10B). On the other hand, if the ball screw 64 rotates counterclockwise by rotational drive of the motor 62, as illustrated in FIG. 10A, in the space 21 of the shaft body 20, the first piece 10a moves to the axial other side and the second piece 10b moves to the axial one side. That is, in this variation, these first and second pieces 10a and 10b are driven to the axially opposite sides, respectively, so that when the first piece 10a is displaced to the axial one side, the second piece 10b is displaced to the axial other side, while when the first piece 10a is displaced to the axial other side, the second piece 10b is displaced to the axial one side.

As a result, as with the above-described embodiment, a first state (see FIG. 10A), in which the second magnetic circuit Q2 is formed, with the first inner peripheral part 32 and second inner peripheral part 33 facing the first larger diameter part 11 and second larger diameter part 12, respectively, and a second state (see FIG. 10B), in which the first piece 10a and second piece 10b are axially displaced away from each other by the axial driving mechanism 60D from the first state and the second magnetic circuit Q2 disappears, can be switched. As a result, as with the above-described embodiment, because the density of magnetic flux of the first magnetic circuit Q1 can be appropriately adjusted, a high-torque characteristic and/or high-speed characteristic can be flexibly achieved while preventing the loss due to a leakage of the magnetic flux.

Moreover, in addition to the above, there are the following effects. That is, when the state is switched from the first state to the second state by displacing the integrally formed magnetic body 10D, which is not divided as with the above-described embodiment, to the axial one side, a magnetic repulsive force may be generated between the magnetic body 10D and the rotor core 30, and thus a force, which attempts to move the shaft body 20 to the axial one side, may be applied also to the shaft body 20. In this case, the shaft bearings 7a and 7b which rotatably support the shaft body 20 need a large rigidity endurable to this movement. In contrast, in this variation, two divided pieces 10a and 10b are displaced away from each other to switch to the second state. As the result, the direction of a force applied to the shaft body 20 by a magnetic repulsive force that is generated on the first piece 10a side and the direction of a force applied to the shaft body 20 by a magnetic repulsive force that is generated on the second piece 10b side become exactly opposite. As a result, these two forces are cancelled out each other, and there is therefore no need to increase the rigidity of the shaft bearing unlike the above-described case.

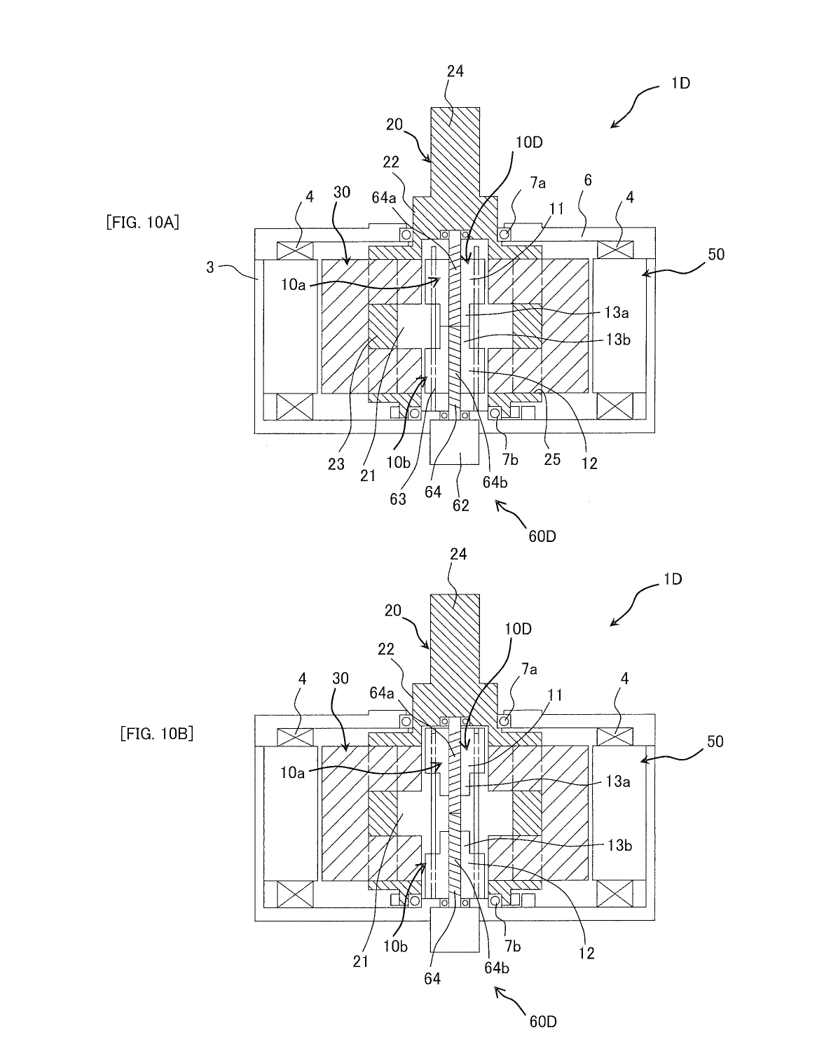

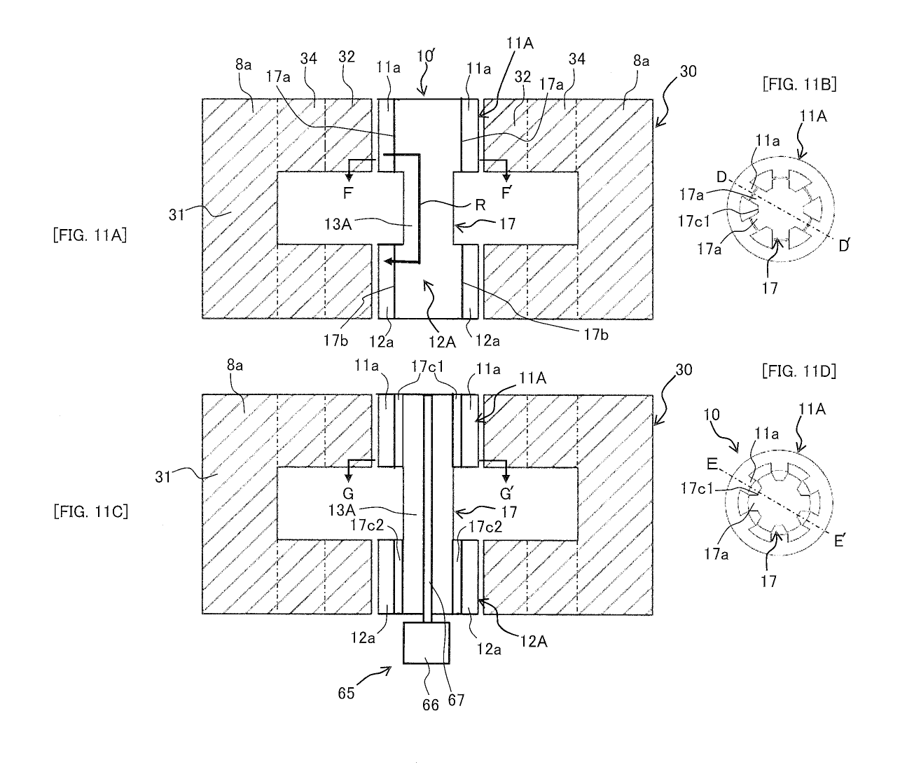

Next, a second embodiment is described using FIG. 11. Note that the same reference numeral is given to the part equivalent to the first embodiment and each of the variations to omit or simplify the description thereof as needed. In this embodiment, a magnetic circuit is controlled by rotating an inner cylinder in a magnetic body having a dual structure of outer/inner cylinders. FIG. 11A is a conceptional radial cross-sectional view illustrating the magnetic body and rotor core in the second embodiment, while FIG. 11B is a transverse cross-sectional view along an F-F′ line in FIG. 11A. Note that FIG. 11A corresponds to a vertical cross-sectional view along a D-D′ line in FIG. 11B.

<Configuration of Magnetic Body>

A magnetic body 10′ in this embodiment includes, as illustrated in FIG. 11A and FIG. 11B, a substantially cylindrical first outer cylindrical part 11A disposed on an axial one side (upper side in each view), a substantially cylindrical second outer cylindrical part 12A disposed on an axial other side (lower side in each view), and a rotor part 17 located and rotatably arranged on a radial inner side of the first outer cylindrical part 11A and second outer cylindrical part 12A.

The first outer cylindrical part 11A includes a plurality of first internal tooth parts 11a each projecting to the radial inner side. Note that the outer shape of the first outer cylindrical part 11A corresponds to the first larger diameter part 11. The second outer cylindrical part 12A includes a plurality of second internal tooth parts 12a each projecting to the radial inner side. Note that the outer shape of the second outer cylindrical part 12A corresponds to the second larger diameter part 12.

The rotor part 17 includes an intermediate connecting part 13A in an axial intermediate part between the first outer cylindrical part 11A and the second outer cylindrical part 12A. The outer shape of the intermediate connecting part 13A corresponds to the first smaller diameter part 13. Moreover, on the axial one side of the rotor part 17, a plurality of first external tooth parts 17a, each of which projects to the radial outer side so as to be able to face each of the plurality of the first internal tooth parts 11a, are disposed. On the axial other side of the rotor part 17, a plurality of second external tooth parts 17b, each of which projects to the radial outer side so as to be able to face each of the plurality of the second internal tooth parts 12a, are disposed.

In the state illustrated in FIG. 11A and FIG. 11B, the first external tooth part 17a of the rotor part 17 faces the first internal tooth part 11a of the first outer cylindrical part 11A, and the second external tooth part 17b of the rotor part 17 faces the second internal tooth part 12a of the second outer cylindrical part 12A. In this state (hereinafter, referred to as a “third state”, as needed), inside the magnetic body 10′, the magnetic flux can be caused to pass through a path R (see FIG. 11A): the first internal tooth part 11a of the first outer cylindrical part 11A→the first external tooth part 17a of the rotor part 17→the intermediate connecting part 13A→the second external tooth part 17b→the second internal tooth part 12a of the second outer cylindrical part 12A. As a result, by causing the first larger diameter part 11 and the second larger diameter part 12 to face the first inner peripheral part 32 and the second inner peripheral part 33 of the rotor core 30, respectively, as described above, the second magnetic circuit Q2 can be formed.

<Rotational Operation of Rotor>

On the other hand, in the above-described configuration, the rotor part 17 is rotationally driven by a rotational driving mechanism 65 so as to be able to rotate around the axis. FIG. 11C is a conceptional radial cross-sectional view illustrating the magnetic body and rotor core after rotation, while FIG. 11D is a transverse cross-sectional view along a G-G′ line in FIG. 11B. Note that FIG. 11C corresponds to the vertical cross-sectional view along an E-E′ line in FIG. 11D.

The rotational driving mechanism 65 includes, as illustrated in FIG. 11C, a motor 66 including a stepping motor, for example, and a rotary shaft 67 fixed to the axial one side of the motor shaft of the motor 66 and also attached to the axis of the rotor part 17. Note that, in FIG. 11A, illustration of the rotational driving mechanism 65 is omitted for the purpose of preventing the illustration from becoming complicated. The rotor part 17 can be displaced in the rotation direction by the motor 66 that rotates the rotor part 17 via the rotary shaft 67. In the state after rotation illustrated in FIG. 11C and FIG. 11D, in the rotor part 17, an inter-teeth part 17c1 between two adjacent first external tooth parts 17a faces the first internal tooth part 11a of the first external tooth part 11A, and an inter-teeth part 17c2 between two adjacent second external tooth parts 17b faces the second internal tooth part 12a of the second external tooth part 12A. As a result, the state is switched to a state (hereinafter, referred to as a “fourth state”, as needed), in which the first external tooth part 17a does not face the first internal tooth part 11a anymore and the second external tooth part 17b does not face the second internal tooth part 12a anymore and thus the second magnetic circuit Q2 disappears. Then, an intermediate state between the third state and the fourth state can be also realized by appropriately adjusting an amount of displacement in the rotation direction caused by the rotational driving mechanism 65. As the result, also in this embodiment, as with the first embodiment, the density of magnetic flux of the first magnetic circuit Q1 can be appropriately adjusted, and a high-torque characteristic and/or high-speed characteristic can be flexibly achieved while preventing the loss due to a leakage of the magnetic flux.

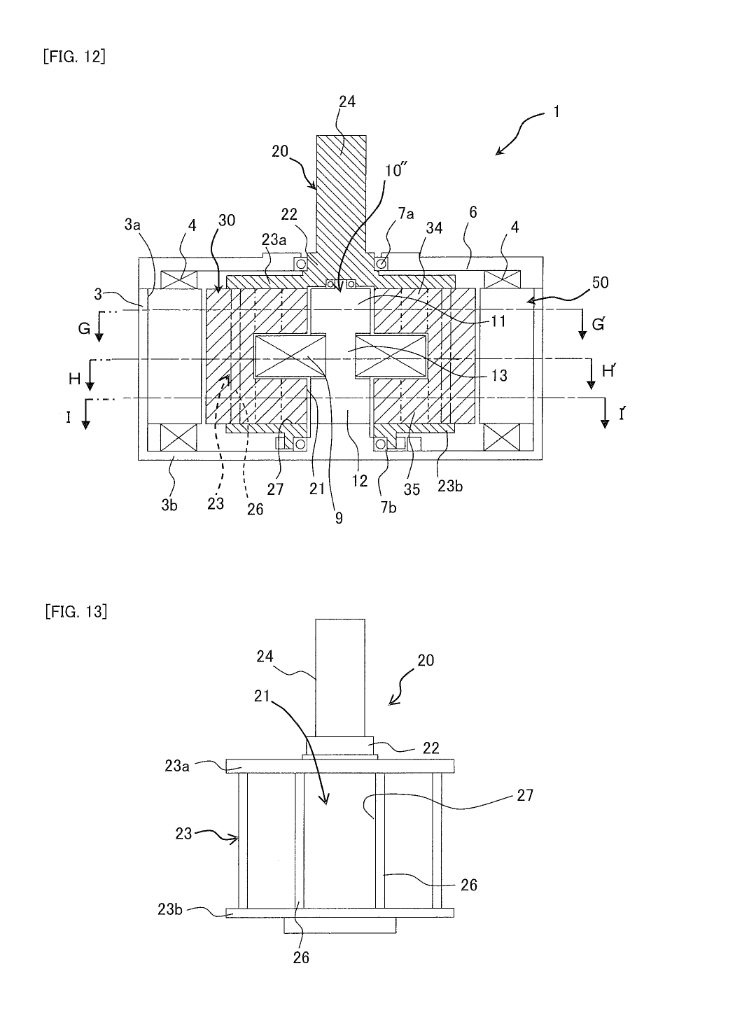

Next, a third embodiment is described using FIG. 12 to FIG. 14. Note that the same reference numeral is given to the part equivalent to the first and second embodiments and each of the variations to omit or simplify the description thereof as needed. In this embodiment, windings are wound around a magnetic body to generate a magnetic flux.

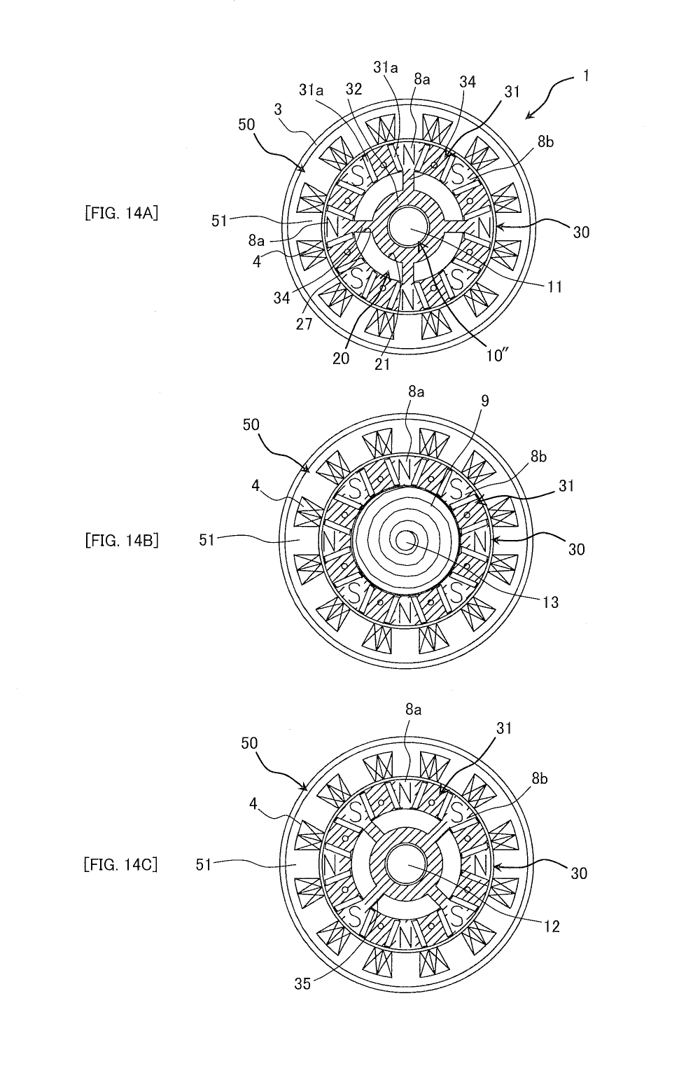

In FIG. 12 to FIG. 14, in the rotary electric machine 1 of this embodiment, windings 9 (corresponding to an example of second windings) capable of generating a magnetic flux is wound around the first smaller diameter part 13 of a magnetic body 10″ housed in the space 21 of the shaft body 20 (see also FIG. 14B). An axial one side (upper side in FIG. 12) part of the magnetic body 10″ housed in the space 21 is rotatably supported on the flange part 22 of the shaft body 20. Moreover, in this embodiment, the axial driving mechanism or rotary driving mechanism as with the first and second embodiments is not disposed, but a part (in other words, the second larger diameter part 12) on the axial other side (lower side in FIG. 12) of the magnetic body 10″ is integrally fixed to the bottom wall part 3b of the case 3.

In a hollow cylindrical body part 23 of the shaft body 20, the top plate part 23a on an axial one side and the bottom wall part 23b on an axial other side are connected by a plurality of columns 26 that extend along the circumferential direction. An opening part 27 is disposed between the adjacent two columns 26 and 26. The flange part 22 disposed on the axial one side of the cylindrical body part 23 is formed in a solid small cylindrical shape.

The rotor core 30 is fixed to the top plate part 23a and bottom wall part 23b of the shaft body 20, with the first connecting part 34 and second connecting part 35 mated into the opening part 27 of the cylindrical body part 23.

The configuration other than the above is the same as that of the first embodiment and thus the description thereof is omitted.

In this embodiment, by energizing the windings 9 disposed on the first smaller diameter part 13 of the magnetic body 10″, the density of magnetic flux of the first magnetic circuit Q1 that passes through the rotor core 30 as described above can be increased or decreased. As a result, as with the first and second embodiments, the density of magnetic flux of the first magnetic circuit Q1 can be appropriately adjusted, and a high-torque characteristic and/or high-speed characteristic can be flexibly achieved while preventing the loss.

Note that, by applying the configuration of the variation (2) to the third embodiment, the magnetic body 10″ can have a multi-stage form including the first smaller diameter part 13 and second smaller diameter part 15. In this case, not only by winding the windings 9 around the first smaller diameter part 13 but also by winding similar windings around the second smaller diameter part 15, the surface area where the windings touch the magnetic body 10″ can be effectively increased to facilitate cooling of the windings. Moreover, as with the variation, a plurality of stages of the first extension part 71 and second extension part 72 may be disposed on the axial other side of the configuration of the magnetic body 10 and rotor core 30 of the first embodiment. As the number of stages is increased further, an increased effect in the surface area where the windings touch the magnetic body 10″ can be further increased.

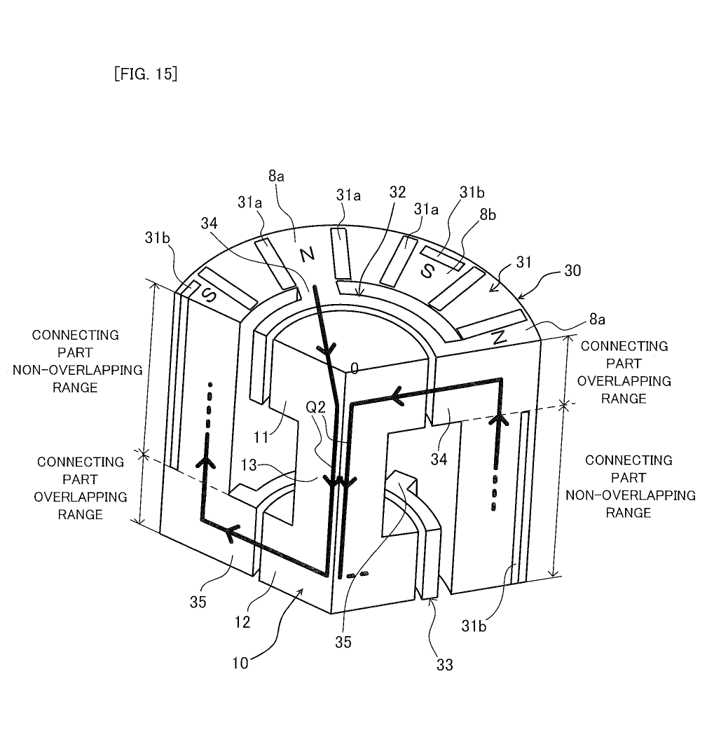

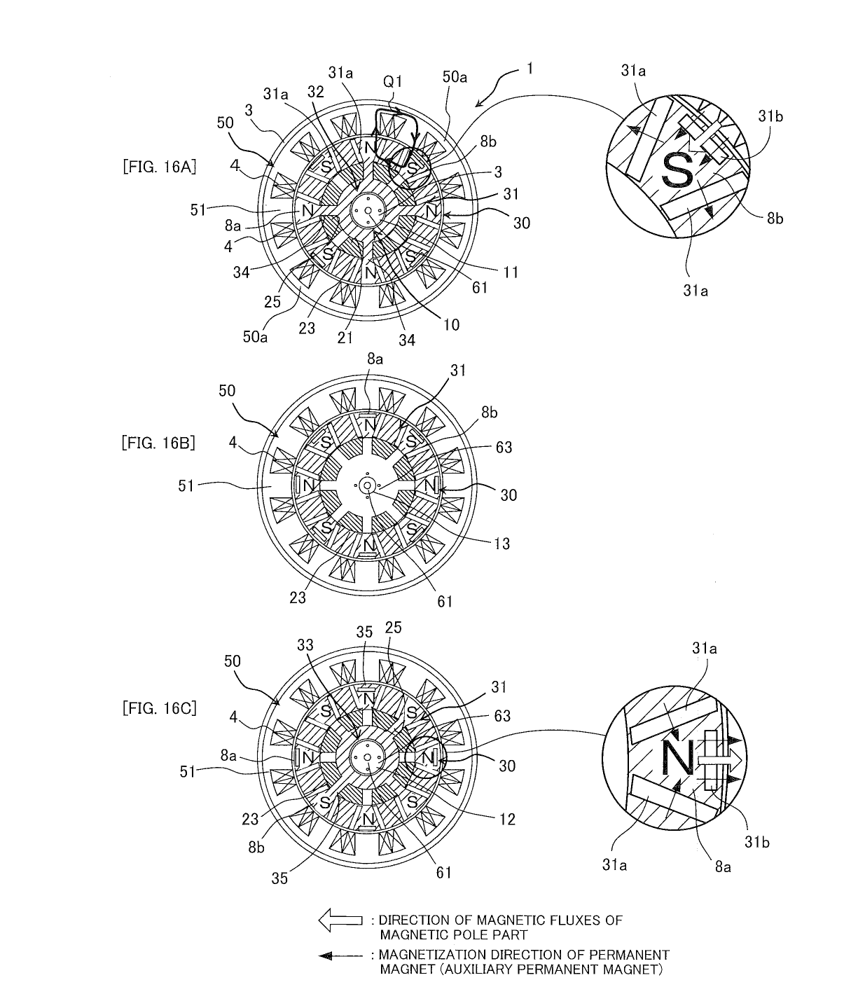

Next, a fourth embodiment is described using FIG. 15 and FIG. 16. Note that the same reference numeral is given to the part equivalent to the first to third embodiments and each of the variations to omit or simplify the description thereof as needed. In this embodiment, the density of magnetic flux of the magnetic circuit Q1 contributing to an increase of the torque is increased by disposing an auxiliary permanent magnet on each magnetic pole part. FIG. 15 is a perspective view of a half body obtained by cutting a rotor core and the inside thereof of a rotary electric machine of the fourth embodiment into a sector form with an inner periphery angle of 135° when seen from an axial transverse cross-section. FIG. 16A to FIG. 16B are the axial transverse cross-sectional views corresponding to FIG. 3A to FIG. 3C, respectively.

<Configuration of Outer Peripheral Part>

In FIG. 15 and FIG. 16, in the rotary electric machine 1 of this embodiment, in the outer peripheral part 31 of the rotor core 30, a tabular auxiliary permanent magnet 31b is disposed on each of the N-magnetic pole part 8a and the S-magnetic pole part 8b. In the example of this embodiment, in each of the N-magnetic pole part 8a and the S-magnetic pole part 8b, the auxiliary permanent magnet 31b is arranged across an entire axial range (“connecting part non-overlapping range” in FIG. 15) in which it does not overlap with the first connecting part 34 or the second connecting part 35. Moreover, each auxiliary permanent magnet 31b is arranged on the outer peripheral side of the N-magnetic pole part 8a or the S-magnetic pole part 8b, with the thickness direction of the tabular shape facing the radial direction. Each auxiliary permanent magnet 31b is magnetized in the same direction as the direction of the magnetic flux of the first magnetic circuit Q1 formed by adjacent permanent magnets 31a.

The configuration other than the above is the same as that of the first embodiment and thus the description thereof is omitted.

<Function of Auxiliary Permanent Magnet>

As one of the measures for increasing the torque of the rotary electric machine 1, there is a technique of increasing the density of the magnetic flux of the magnetic circuit Q1 radiated toward the stator core 50 by increasing the number of the permanent magnets included in the rotor core 30. However, the positions, where the permanent magnet can be added inside the rotor core 30, are limited without enlarging the entire physical size (diameter) of the rotor core 30. Moreover, because on the inner peripheral side of the rotor core 30, the above-described magnetic flux density adjustment structure is included, a consideration needs to be taken such that the permanent magnet disposed on the outer peripheral part 31 will not affect the magnetoresistance or the like of the magnetic circuit Q2 formed by such a magnetic flux density adjustment structure.

Here, in the rotor core 30 having a general IPM configuration, a plurality of tabular permanent magnets 31a are arranged in the circumferential direction in the outer peripheral part 30 including a magnetic body, as described above. Among the tabular permanent magnets, two permanent magnets 31a sandwiching the area, whose cross section is truncated cone-shaped, are magnetized in the mutually-opposed directions in the circumferential direction. Therefore, a segment sandwiched by these two permanent magnets 31a serves as the N-magnetic pole part 8a and as the S-magnetic pole part 8b, and attempts to radiate the magnetic fluxes both to the radially outward and radially inward of the rotor core 30. For example, a segment between two permanent magnets 31a facing each other in the N-pole direction serves as the N-magnetic pole part 8a, and attempts to radiate the magnetic fluxes with the N-pole directed to each of the radially outward and radially inward of the rotor core 30. Moreover, a segment between two permanent magnets 31a facing each other in the S-pole direction serves as the S-magnetic pole part 8b, and attempts to radiate the magnetic fluxes with the S polarity directed to each of the radially outward and radially inward of the rotor core 30.

However, as the magnetic circuit actually formed in a “connecting part non-overlapping range” of each of the N-magnetic pole part 8a and the S-magnetic pole part 8b, even in the first state the second magnetic circuit Q2 communicating to the radially inward is not formed but only the first magnetic circuit Q1 communicating to the radially outward is always formed. This is because a portion between the outer peripheral part 31 and the stator cores 50 always allows the passage of magnetic fluxes through a narrow magnetic gap, while the outer peripheral part 31 and the first and second inner peripheral parts 32, 33 are separated with a wide gap in the slit 25 of the shaft body 20 (i.e., the outer peripheral part 31 and the first and second inner peripheral parts 32, 33 are not connected to each of the connecting parts 34, 35) and therefore the portion between the outer peripheral part 31 and the first and second inner peripheral parts 32, 33 always does not allow the passage of magnetic fluxes (see FIG. 16A and FIG. 16C).

In this embodiment, in the “connecting part non-overlapping range” of each of the N-magnetic pole part 8a and S-magnetic pole part 8b of the outer peripheral part 31, the auxiliary permanent magnet 31b that is magnetized in the same direction as the direction of the magnetic flux of the first magnetic circuit Q1 formed by the adjacent permanent magnets 31a is included (see the enlarged parts in FIG. 16A and FIG. 16C). As a result, the density of magnetic flux of the magnetic circuit Q1 formed toward the stator core 50 on the outer peripheral side of the rotor core 30 can be increased, and the torque of the rotary electric machine 1 can be increased.

Moreover, the magnetic circuit Q2 formed by the above-described magnetic flux density adjustment structure radially advances or penetrates with respect to the N-magnetic pole part 8a and S-magnetic pole part 8b of the outer peripheral part 31 through the axial range (“connecting part overlapping range” in FIG. 15) in which it overlaps with the first connecting part 34 or the second connecting part 35. Then, in this embodiment, the auxiliary permanent magnet 31b magnetized in the above-described pole direction is included in the axial range in which it does not overlap with the first connecting part 34 or the second connecting part 35 in each of the N-magnetic pole part 8a and the S-magnetic pole part 8b. As a result, the magnetic flux radiated in the radial direction from each auxiliary permanent magnet 31b will not face the magnetic flux of the magnetic circuit Q2 passing through the inside of each of the connecting parts 34 and 35, but just becomes perpendicular to the magnetic flux of the magnetic circuit Q2 in the connecting part non-overlapping range. That is, the magnetic flux radiated by the auxiliary permanent magnet 31b will not apply a magnetoresistance to the magnetic flux of the magnetic circuit Q2 formed by magnetic flux density adjustment structure, and can suppress an effect on the magnetic flux density adjustment function. As a result, the torque of the rotary electric machine 1 can be increased while preventing an increase of the physical size and an effect on the magnetic flux density adjustment function. Moreover, according to the configuration of the embodiment, even if the auxiliary permanent magnet 31b is disposed, a variable width of the magnetic flux density adjustment function will not be damaged.

Note that, in this embodiment, each auxiliary permanent magnet 31b is arranged across the entire connecting part non-overlapping range. But not limited to this, the auxiliary permanent magnet 31 may have any length and be arranged at any axial position, if within the connecting part non-overlapping range. Notably, each auxiliary permanent magnet 31b is preferably arranged, with the edge part thereof aligned with the edge part of the N-magnetic pole part 8a or S-magnetic pole part 8b, on the axially opposite side of each of the connecting parts 34 and 35. The auxiliary permanent magnet 31b is arranged at a position farthest from each of the connecting parts 34 and 35 in this manner, so that the magnetoresistance with respect to the radial path of the magnetic circuit Q2 can be minimized. Moreover, the axial length of each auxiliary permanent magnet 31b is set to be the same size and each auxiliary permanent magnet 31b is arranged symmetrically between on the axial one side and on the axial other side of the N-magnetic pole part 8a or the S-magnetic pole part 8b, so that the balance of the flux density distribution in the circumferential direction becomes excellent.

Moreover, because each auxiliary permanent magnet 31b is arranged on the substantially outer peripheral side of the N-magnetic pole part 8a or S-magnetic pole part 8b, each auxiliary permanent magnet 31b can maximize the density of magnetic flux with respect to the stator core 50 positioned on the outer peripheral side of the rotor core 30 and maximize the torque.

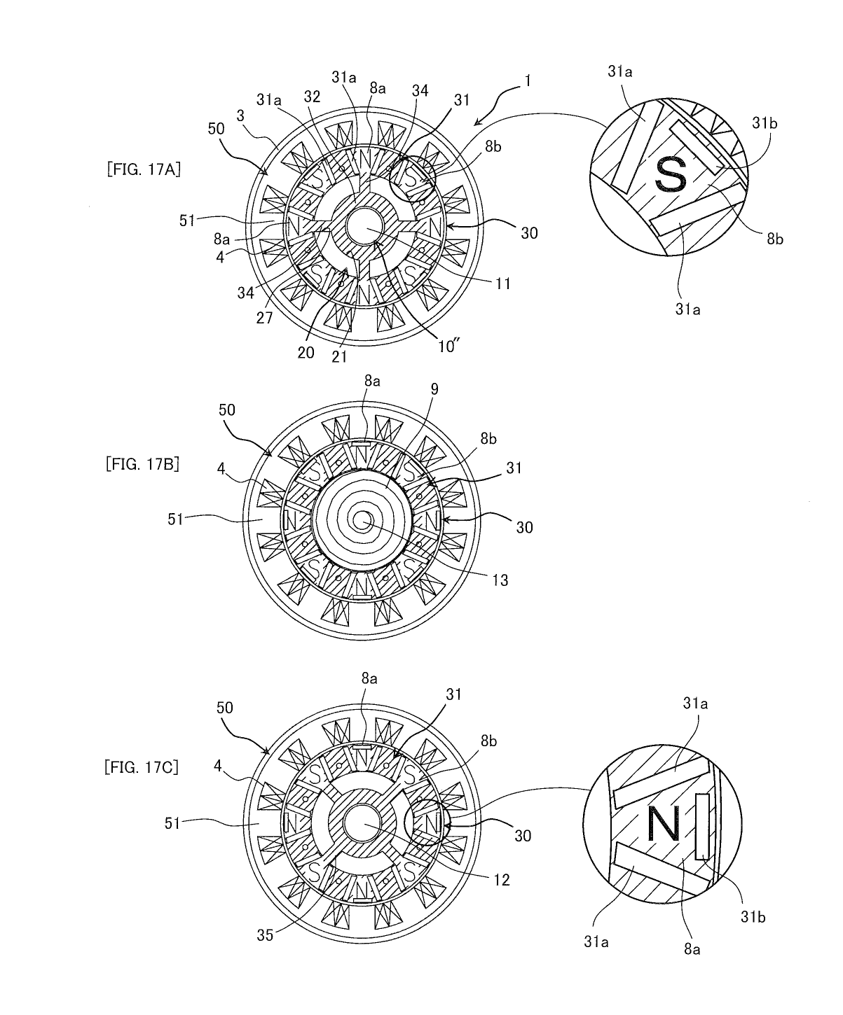

Note that the configuration of the above-described third embodiment may be combined with the configuration of the fourth embodiment. That is, as illustrated in FIGS. 17A to 17C of the axial cross section corresponding to FIG. 14 and FIG. 16, the winding 9 capable of generating magnetic fluxes is wound around the first smaller diameter part 13 of the magnetic body 10″, and the auxiliary permanent magnet 31b is included in the connecting part non-overlapping range of each of the N-magnetic pole part 8a and S-magnetic pole part 8b of the outer peripheral part 31. Even in this case, the magnetic flux density adjustment function of the first magnetic circuit Q1 can be realized, and the torque of the rotary electric machine 1 can be increased while preventing an increase of the physical size and an effect on the magnetic flux density adjustment function.

Moreover, in the above, the first columnar part, second columnar part, and third columnar part include the first larger diameter part 11, second larger diameter part 12, and first smaller diameter part 13, respectively, and the fifth columnar part and fourth columnar part include the third larger diameter part 14 and second smaller diameter part 15, respectively, but the present disclosure is not limited thereto. As long as the density of magnetic flux of the first magnetic circuit Q1 can be increased or decreased using the above-described technique, the magnitude relationship between the diameters of the respective parts may be reversed or non-adjacent parts may have the same diameter.

Note that, in the above, a case has been described, where the rotary electric machine 1 is of an inner rotor type having the rotor core 30 inside the stator core 50, as an example, but the present disclosure may be applicable also to an outer rotor type rotary electric machine having a stator core inside the rotor core. Furthermore, in the above, a case has been described, where the rotary electric machine 1 is a motor (more specifically, synchronous motor), as an example, but the present disclosure may be applicable also to a case where the rotary electric machine 1 is a generator.

Moreover, other than the embodiments and variations described above, the techniques according to the embodiments and variations may be combined and used, as needed.

Other than the above, though not illustrated one by one, the embodiments and variations may be variously modified and implemented without departing from the scope of the present disclosure.

What is claimed is:

1. A rotary electric machine comprising:
a magnetic body including at least a first columnar part located on an axial one side, a second columnar part located on an axial other side, a third columnar part located at an axial intermediate part between the first columnar part and the second columnar part;
a rotatable shaft body including a space capable of housing the magnetic body;
a rotor core including:
an outer peripheral part fixed to the shaft body, the outer peripheral part including a first magnet pole part and a second magnet pole part alternately arranged extending along a circumferential direction, the first magnet pole part and second magnet pole part each having a different magnet pole direction with respect to a radial direction;
a first inner peripheral part disposed on the axial one side on a radial inner side of the outer peripheral part, the first inner peripheral part being capable of facing a radial outer side of the first columnar part;
a second inner peripheral part disposed on the axial other side on the radial inner side of the outer peripheral part, the second inner peripheral part being capable of facing a radial outer side of the second columnar part;
a first connecting part that radially connects the first inner peripheral part and an arrangement part of the first magnetic pole part of the outer peripheral part; and
a second connecting part that radially connects the second inner peripheral part and an arrangement part of the second magnetic pole part of the outer peripheral part;
a stator core disposed on a radial outer side of the rotor core; and
first windings disposed on the stator core.

2. The rotary electric machine according to claim 1, further comprising an axial driving mechanism capable of axially displacing the magnetic body in the space of the shaft body.

3. The rotary electric machine according to claim 2, wherein:
the magnetic body has a structure divided into a first piece on the axial one side including the first columnar part and a second piece on the axial other side including the second columnar part, and
the axial driving mechanism displaces the second piece to the axial other side when displacing the first piece to the axial one side, while when displacing the first piece to the axial other side, the first driving unit displaces the second piece to the axial one side.

4. The rotary electric machine according to claim 1, wherein:
second wirings capable of generating a magnetic flux are wound around the third columnar part of the magnetic body.

5. The rotary electric machine according to claim 2, wherein:
the magnetic body includes at least one first extension part on further the axial other side of the second columnar part, the at least one first extension part including:
a fourth columnar part located on further the axial other side of the second columnar part; and
a fifth columnar part located on further the axial other side of the fourth columnar part, and
the rotor core includes a same number of second extension parts as a number of the first extension parts on further the axial other side of the second columnar part, the second extension parts including:
a third inner peripheral part disposed on further the axial other side of the second inner peripheral part on the radial inner side of the outer peripheral part, the third inner peripheral part being capable of facing a radial outer side of the fifth columnar part; and
a third connecting part that radially connects the third inner peripheral part and an arrangement part of the first magnetic pole part of the outer peripheral part.

6. The rotary electric machine according to claim 4, wherein:
the magnetic body includes at least one first extension part on further the axial other side of the second columnar part, the at least one first extension part including:
a fourth columnar part located on further the axial other side of the second columnar part; and
a fifth columnar part located on further the axial other side of the fourth columnar part, and
the rotor core includes a same number of second extension parts as a number of the first extension parts on further the axial other side of the second columnar part, the second extension parts including:
a third inner peripheral part disposed on further the axial other side of the second inner peripheral part on the radial inner side of the outer peripheral part, the third inner peripheral part being capable of facing a radial outer side of the fifth columnar part; and
a third connecting part that radially connects the third inner peripheral part and an arrangement part of the first magnetic pole part of the outer peripheral part.

7. The rotary electric machine according to claim 5, wherein:
a permanent magnet is disposed on an outer peripheral part of at least one of the first columnar part, the second columnar part, and the fifth columnar part, or a permanent magnet is disposed on an outer peripheral part of at least one of the third columnar part and the fourth columnar part.

8. The rotary electric machine according to claim 1, wherein:
the magnetic body includes:
a approximately cylindrical first outer cylindrical part including a plurality of first internal tooth parts each projecting to the radial inner side, the first outer cylindrical part being disposed on the axial one side, an outer periphery of the first outer cylindrical part constituting the first columnar part;
a approximately cylindrical second outer cylindrical part including a plurality of second internal tooth parts each projecting to the radial inner side, the second outer cylindrical part being disposed on the axial other side, an outer periphery of the second outer cylindrical part constituting the second columnar part; and
a rotor part that includes, on the axial one side, a plurality of first external tooth parts each projecting to a radial outer side so as to be able to face each of the plurality of first internal tooth parts, and includes, on the axial other side, a plurality of second external tooth parts each projecting to the radial outer side so as to be able to face each of the plurality of second internal tooth parts, and includes, in an axial intermediate part between the first outer cylindrical part and the second outer cylindrical part, an intermediate connecting part whose outer shape constitutes the third columnar part, and the rotor part being arranged rotatably, and
the rotary electric machine further includes a rotational driving mechanism capable of driving the rotor part in a rotation direction.

9. The rotary electric machine according to any one of claims 1 to 8, wherein:
the rotor core includes, in at least one of the first magnetic pole part and the second magnetic pole part of the outer peripheral part, in a axial range where the range does not overlap with the first connecting part or the second connecting part, an auxiliary permanent magnet magnetized in a same direction as a direction of a magnetic flux of a magnetic circuit formed by adjacent permanent magnets.

10. The rotary electric machine according to claim 9, wherein:
the auxiliary permanent magnet is arranged, with an edge part of the auxiliary permanent magnet aligned with an edge part of the first magnetic pole part or the second magnetic pole part in an axial direction, on an axially opposite side of the first connecting part or the second connecting part.

11. The rotary electric machine according to claim 10, wherein:
the auxiliary permanent magnet is arranged on a approximately outer peripheral side of the first magnetic pole part or the second magnetic pole part.

12. A rotary electric machine comprising:
a rotor core;
a magnetic body disposed on a radial inner side of the rotor core;
a stator core disposed on a radial outer side of the rotor core; and
means for adjusting a balance of a magnetic flux density of a first magnetic circuit and a magnetic flux density of a second magnetic circuit, the first magnetic circuit being formed between a magnet pole part of the rotor core and the stator core, the second magnetic circuit being formed between the magnet pole part and the magnetic body.
